(19) United States
(12) Patent Application Publication
(10) Pub. No.: US 2024/0389492 A1
(43) Pub. Date: Nov. 28, 2024

(54) LIGHT INTENSITY MANAGEMENT WITHIN A REGION OF INTEREST

(71) Applicant: Deere & Company, Moline, IL (US)

(72) Inventors: STEVEN REES, Top Camp (AU); Tarik Loukili, Urbandale, IA (US)

(21) Appl. No.: 18/201,432

(22) Filed: May 24, 2023

(51) Int. Cl. A01B 69/00; A01B 69/04; G06V 10/25; G06V 10/60; G06V 20/10; G06V 20/56

(52) U.S. Cl. CPC A01B 69/001; A01B 69/008; G06V 10/25; G06V 10/60; G06V 20/188; G06V 20/56

(57) ABSTRACT

An automated farming machine can operate in low light environments (e.g., at night) using one or more lights, attached to a boom, to illuminate the ground surface of a field for cameras of the machine. The cameras capture images of the field, which the machine processes by identifying a region of interest (ROI) within the image and a plant within the ROI. The boom moves as the machine goes over uneven ground, causing the brightness captured in the images to change. The machine may analyze a portion of the ground surface that is illuminated to identify an ROI within the image. The machine identifies the ROI by comparing the brightness of the image to a threshold brightness level. The machine takes actions based on the ROI, such as spraying herbicide on a weed identified in the ROI at a certain time after identifying the weed.

### BACKGROUND

### Field of Disclosure

This disclosure relates generally to a farming machine treating plants in a field, and more specifically to identifying region of interests as the farming machine treats plants in the field.

### Description of the Related Art

Farming machines implement different plant treatments depending on the type of plant. When lighting conditions are sufficient, a human operator of a farming machine can identify the type of plant and consequently, the treatment to perform on the identified plant. Human operators are limited to daylight operations due to lighting conditions, and similar conditions affect autonomous farming machines as well. In poor lighting conditions, identifying a plant type to perform the proper treatment is a challenge.

### SUMMARY

The plant treatment using an identified region of interest (ROI) described herein implements image processing to optimize treatment during low light operations of the farming machine. A control system of an automated farming machine can operate in low light environments (e.g., at night) using one or more lights, attached to a boom, to illuminate the ground surface of a field for cameras of the automated farming machine. The cameras capture images of the field, which the control system processes by identifying an ROI within the image and a plant within the ROI.

The boom moves as the automated farming machine goes over uneven ground, causing the brightness captured in the images to change (e.g., location, size, or intensity of the lighting on the ground surface). The control system may analyze a portion of the ground surface that is illuminated to identify an ROI within the image (e.g., the most-lit portion). The control system identifies the ROI by comparing the brightness of the images to a threshold brightness level. The control system may take actions based on the ROI, such as spraying herbicide on a weed identified in the ROI at a certain time after identifying the weed.

In one embodiment, an autonomous farming machine detects a brightness level at each of one or more points of a ground surface in front of a boom of the autonomous farming machine. The boom may include one or more lights configured to illuminate the ground surface in front of the boom when the autonomous farming machine operates at night. The autonomous farming machine identifies a region of interest corresponding to a portion of the ground surface in front of the boom corresponding to an above-threshold detected brightness level. The autonomous farming machine detects a plant within the identified region of interest. The autonomous farming machine selects an action based on the detected plant. The autonomous farming machine then performs the selected action at a delayed time based on a location of the region of interest.

### BRIEF DESCRIPTION OF DRAWINGS

FIG. 1A is an isometric view of a farming machine that performs farming actions of a treatment plan, according to one example embodiment.

FIG. 1B is a top view of the farming machine in FIG. 1A, according to one example embodiment.

FIG. 1C is an isometric view of another farming machine that performs farming actions of a treatment plan, according to one example embodiment.

FIG. 2 is a block diagram of the system environment for the farming machine, in accordance with one or more example embodiments.

FIG. 3 illustrates an example of the treatment module, according to one example embodiment.

FIG. 4A illustrates an accessed image of the field captured by the farming machine, according to one example embodiment.

FIG. 4B illustrates a labeled image of the field, according to one example embodiment.

FIG. 5 depicts a region of interest identification view of a ground surface in front of an autonomous farming machine, according to one embodiment.

FIGS. 6A and 6B show light intensity determination views within the region of interest of FIG. 5, according to one embodiment.

FIG. 7 depicts a process for treating a plant detected in an identified region of interest, according to one embodiment.

FIG. 8 is a block diagram illustrating components of an example machine for reading and executing instructions from a machine-readable medium.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### I. Introduction

Agronomists may use farming machines to treat plants in a field. The farming machines are equipped with treatment mechanisms to apply treatments to the plants. Treatments include, for example, growth regulators (e.g., pesticide, insecticide, herbicide, etc.) or promoters (e.g., fertilizers) to the plants. Fields often contain more than one crop, as well as undesirable plants, like weeds, each of which may require different types of treatment.

As the farming machines move towards autonomous or semi-autonomous configurations, the farming machines increasingly rely on computer models and machine vision to accomplish various tasks independently (e.g., applying treatments without input from the agronomist). For example, farming machines may rely on image processing to identify plants when operating in low light conditions (e.g., at night).

The methods presented herein describe a farming machine configured to identify a plant in a region of interest (ROI), where the farming machine configured to identify the ROI based on light intensities of images captured as the farming machine travels through the field. The farming machine may be configured to determine the ROI in real-time, either immediately before a executing route through a field to perform farming operations, which may be referred to as a “farming pass,” or during a farming pass. In either case, the farming machine captures images plants in the field, identifies an ROI in the captured images based on light intensity, identifies plants in the image, determines an action to perform based on the identified plant, and determines a time to perform the action based on the location of the ROI. The farming machine includes a number of treatment mechanisms, such as nozzles, such that the farming machine can treat identified plants using the modified models. One or more treatment mechanisms may also be referred to as a “treatment array.” The farming machine may use the treatment array at a delayed time from when the plant is first identified in the ROI.

### II. Field Management

Agricultural managers (“managers”) are responsible for managing farming operations in one or more fields. Managers work to implement a farming objective within those fields and select from among a variety of farming actions to implement that farming objective. Traditionally, managers are, for example, a farmer or agronomist that works the field but could also be other people and/or systems configured to manage farming operations within the field. For example, a manager could be an automated farming machine, a machine learned computer model, etc. In some cases, a manager may be a combination of the managers described above. For example, a manager may include a farmer assisted by a machine learned agronomy model and one or more automated farming machines or could be a farmer and an agronomist working in tandem.

Managers implement one or more farming objectives for a field. A farming objective is typically a macro-level goal for a field. For example, macro-level farming objectives may include treating crops with growth promoters, neutralizing weeds with growth regulators, harvesting a crop with the best possible crop yield, or any other suitable farming objective. However, farming objectives may also be a micro-level goal for the field. For example, micro-level farming objectives may include treating a particular plant in the field, repairing or correcting a part of a farming machine, requesting feedback from a manager, etc. Of course, there are many possible farming objectives and combinations of farming objectives, and the previously described examples are not intended to be limiting.

Farming objectives are accomplished by one or more farming machines performing a series of farming actions. Farming machines are described in greater detail below. Farming actions are any operation implementable by a farming machine within the field that works towards a farming objective. Consider, for example, a farming objective of harvesting a crop with the best possible yield. This farming objective requires a litany of farming actions, e.g., planting the field, fertilizing the plants, watering the plants, weeding the field, harvesting the plants, evaluating yield, etc. Similarly, each farming action pertaining to harvesting the crop may be a farming objective in and of itself. For instance, planting the field can require its own set of farming actions, e.g., preparing the soil, digging in the soil, planting a seed, etc.

In other words, managers implement a treatment plan in the field to accomplish a farming objective. A treatment plan is a hierarchical set of macro-level and/or micro-level objectives that accomplish the farming objective of the manager. Within a treatment plan, each macro or micro-objective may require a set of farming actions to accomplish, or each macro or micro-objective may be a farming action itself. So, to expand, the treatment plan is a temporally sequenced set of farming actions to apply to the field that the manager expects will accomplish the farming objective.

When executing a treatment plan in a field, the treatment plan itself and/or its constituent farming objectives and farming actions have various results. A result is a representation as to whether, or how well, a farming machine accomplished the treatment plan, farming objective, and/or farming action. A result may be a qualitative measure such as “accomplished” or “not accomplished,” or may be a quantitative measure such as “40 pounds harvested,” or “1.25 acres treated.” Results can also be positive or negative, depending on the configuration of the farming machine or the implementation of the treatment plan. Moreover, results can be measured by sensors of the farming machine, input by managers, or accessed from a datastore or a network.

Traditionally, managers have leveraged their experience, expertise, and technical knowledge when implementing farming actions in a treatment plan. In a first example, a manager may spot check weed pressure in several areas of the field to determine when a field is ready for weeding. In a second example, a manager may refer to previous implementations of a treatment plan to determine the best time to begin planting a field. Finally, in a third example, a manager may rely on established best practices in determining a specific set of farming actions to perform in a treatment plan to accomplish a farming objective.

Leveraging manager and historical knowledge to make decisions for a treatment plan affects both spatial and temporal characteristics of a treatment plan. For instance, farming actions in a treatment plan have historically been applied to an entire field rather than small portions of a field. To illustrate, when a manager decides to plant a crop, she plants the entire field instead of just a corner of the field having the best planting conditions; or, when the manager decides to weed a field, she weeds the entire field rather than just a few rows. Similarly, each farming action in the sequence of farming actions of a treatment plan are historically performed at approximately the same time. For example, when a manager decides to fertilize a field, she fertilizes the field at approximately the same time; or, when the manager decides to harvest the field, she does so at approximately the same time.

Notably though, farming machines have greatly advanced in their capabilities. For example, farming machines continue to become more autonomous, include an increasing number of sensors and measurement devices, employ higher amounts of processing power and connectivity, and implement various machine vision algorithms to enable managers to successfully implement a treatment plan.

Because of this increase in capability, managers are no longer limited to spatially and temporally monolithic implementations of farming actions in a treatment plan. Instead, managers may leverage advanced capabilities of farming machines to implement treatment plans that are highly localized and determined by real-time measurements in the field. In other words, rather than a manager applying a “best guess” treatment plan to an entire field, they can implement individualized and informed treatment plans for each plant in the field.

### III. Farming Machine

### Overview

A farming machine that implements farming actions of a treatment plan may have a variety of configurations, some of which are described in greater detail below.

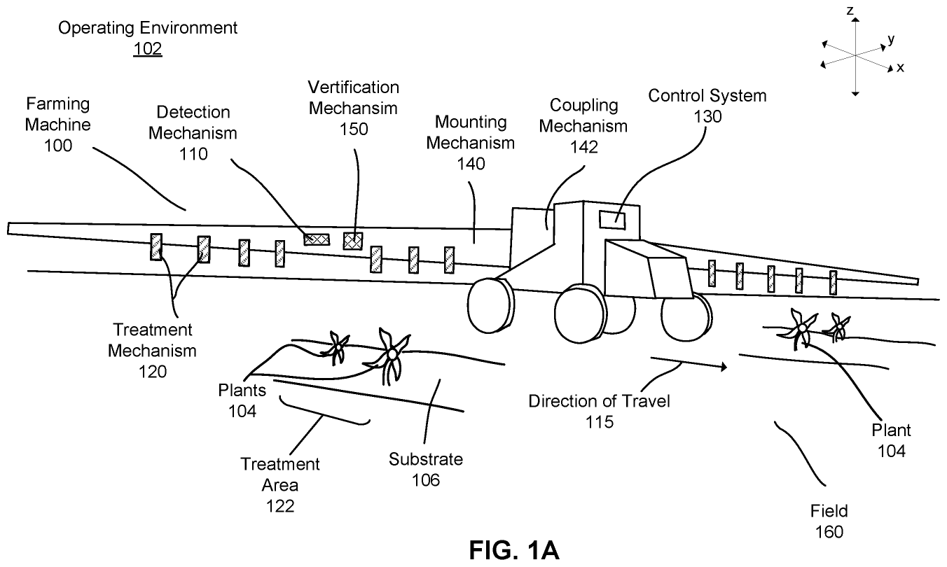

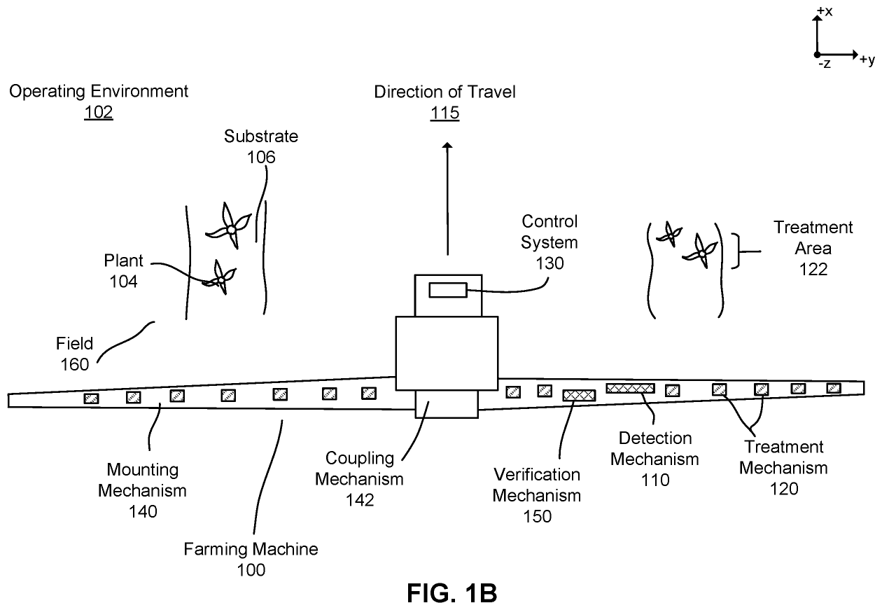

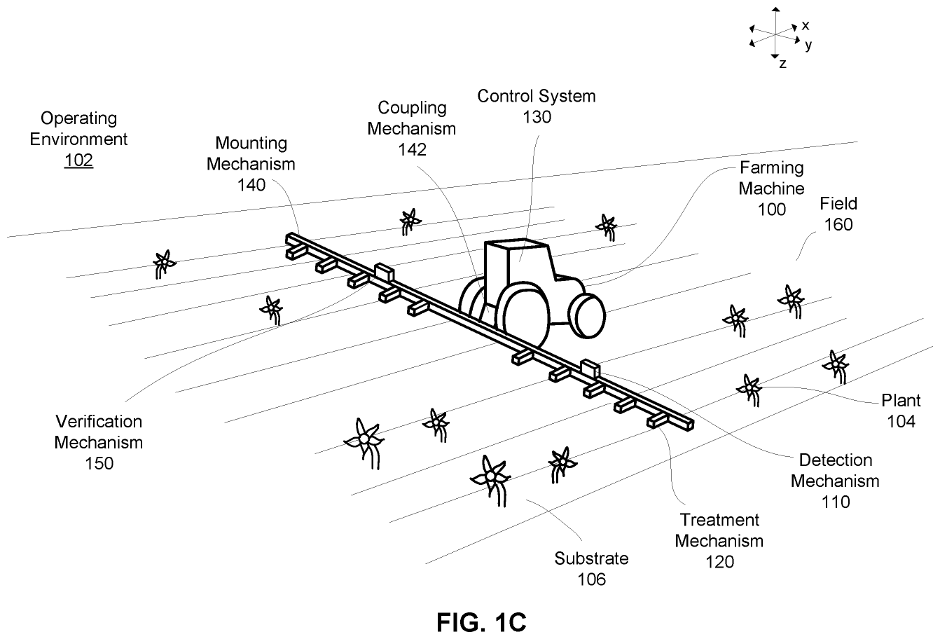

FIG. 1A is an isometric view of a farming machine 100 that performs farming actions of a treatment plan, according to one example embodiment, and FIG. 1B is a top view of the farming machine 100 in FIG. 1A. FIG. 1C is an isometric view of another farming machine 100 that performs farming actions of a treatment plan, according to one example embodiment.

The farming machine 100 includes a detection mechanism 110, a treatment mechanism 120, and a control system 130. The farming machine 100 can additionally include a mounting mechanism 140, a verification mechanism 150, a power source, digital memory, communication apparatus, or any other suitable component that enables the farming machine 100 to implement farming actions in a treatment plan. Moreover, the described components and functions of the farming machine 100 are just examples, and a farming machine 100 can have different or additional components and functions other than those described below.

The farming machine 100 is configured to perform farming actions in a field 160, and the implemented farming actions are part of a treatment plan. To illustrate, the farming machine 100 implements a farming action which applies a treatment to one or more plants 104 and/or the substrate 106 within a geographic area. Here, the treatment farming actions are included in a treatment plan to regulate plant growth. As such, treatments are typically applied directly to a single plant 104, but can alternatively be directly applied to multiple plants 104, indirectly applied to one or more plants 104, applied to the environment 102 associated with the plant 104 (e.g., soil, atmosphere, or other suitable portion of the plant's environment adjacent to or connected by an environmental factors, such as wind), or otherwise applied to the plants 104.

In a particular example, the farming machine 100 is configured to implement a farming action which applies a treatment that necroses the entire plant 104 (e.g., weeding) or part of the plant 104 (e.g., pruning). In this case, the farming action can include dislodging the plant 104 from the supporting substrate 106, incinerating a portion of the plant 104 (e.g., with directed electromagnetic energy such as a laser), applying a treatment concentration of working fluid (e.g., fertilizer, hormone, water, etc.) to the plant 104, or treating the plant 104 in any other suitable manner.

In another example, the farming machine 100 is configured to implement a farming action which applies a treatment to regulate plant growth. Regulating plant growth can include promoting plant growth, promoting growth of a plant portion, hindering (e.g., retarding) plant 104 or plant portion growth, or otherwise controlling plant growth. Examples of regulating plant growth includes applying growth hormone to the plant 104, applying fertilizer to the plant 104 or substrate 106, applying a disease treatment or insect treatment to the plant 104, electrically stimulating the plant 104, watering the plant 104, pruning the plant 104, or otherwise treating the plant 104. Plant growth can additionally be regulated by pruning, necrosing, or otherwise treating the plants 104 adjacent to the plant 104.

### Operating Environment

The farming machine 100 operates in an operating environment 102. The operating environment 102 is the environment 102 surrounding the farming machine 100 while it implements farming actions of a treatment plan. The operating environment 102 may also include the farming machine 100 and its corresponding components itself.

The operating environment 102 typically includes a field 160, and the farming machine 100 generally implements farming actions of the treatment plan in the field 160. A field 160 is a geographic area where the farming machine 100 implements a treatment plan. The field 160 may be an outdoor plant field but could also be an indoor location that houses plants such as, e.g., a greenhouse, a laboratory, a grow house, a set of containers, or any other suitable environment 102.

A field 160 may include any number of field portions. A field portion is a subunit of a field 160. For example, a field portion may be a portion of the field 160 small enough to include a single plant 104, large enough to include many plants 104, or some other size. The farming machine 100 can execute different farming actions for different field portions. For example, the farming machine 100 may apply an herbicide for some field portions in the field 160, while applying a pesticide in another field portion. Moreover, a field 160 and a field portion are largely interchangeable in the context of the methods and systems described herein. That is, treatment plans and their corresponding farming actions may be applied to an entire field 160 or a field portion depending on the circumstances at play.

The operating environment 102 may also include plants 104. As such, farming actions the farming machine 100 implements as part of a treatment plan may be applied to plants 104 in the field 160. The plants 104 can be crops but could also be weeds or any other suitable plant 104. Some example crops include cotton, lettuce, soybeans, rice, carrots, tomatoes, corn, broccoli, cabbage, potatoes, wheat, or any other suitable commercial crop. The weeds may be grasses, broadleaf weeds, thistles, or any other suitable determinantal weed.

More generally, plants 104 may include a stem that is arranged superior to (e.g., above) the substrate 106 and a root system joined to the stem that is located inferior to the plane of the substrate 106 (e.g., below ground). The stem may support any branches, leaves, and/or fruits. The plant 104 can have a single stem, leaf, or fruit, multiple stems, leaves, or fruits, or any number of stems, leaves or fruits. The root system may be a tap root system or fibrous root system, and the root system may support the plant 104 position and absorb nutrients and water from the substrate 106. In various examples, the plant 104 may be a vascular plant 104, non-vascular plant 104, ligneous plant 104, herbaceous plant 104, or be any suitable type of plant 104.

Plants 104 in a field 160 may be grown in one or more plant 104 rows (e.g., plant 104 beds). The plant 104 rows are typically parallel to one another but do not have to be. Each plant 104 row is generally spaced between 2 inches and 45 inches apart when measured in a perpendicular direction from an axis representing the plant 104 row. Plant 104 rows can have wider or narrower spacings or could have variable spacing between multiple rows (e.g., a spacing of 12 in. between a first and a second row, a spacing of 16 in. a second and a third row, etc.).

Plants 104 within a field 160 may include the same type of crop (e.g., same genus, same species, etc.). For example, each field portion in a field 160 may include corn crops. However, the plants 104 within each field 160 may also include multiple crops (e.g., a first, a second crop, etc.). For example, some field portions may include lettuce crops while other field portions include pig weeds, or, in another example, some field portions may include beans while other field portions include corn. Additionally, a single field portion may include different types of crop. For example, a single field portion may include a soybean plant 104 and a grass weed.

The operating environment 102 may also include a substrate 106. As such, farming actions the farming machine 100 implements as part of a treatment plan may be applied to the substrate 106. The substrate 106 may be soil but can alternatively be a sponge or any other suitable substrate 106. The substrate 106 may include plants 104 or may not include plants 104 depending on its location in the field 160. For example, a portion of the substrate 106 may include a row of crops, while another portion of the substrate 106 between crop rows includes no plants 104.

### III.A Example Machine Configurations

### Detection Mechanism(s)

The farming machine 100 may include a detection mechanism 110. The detection mechanism 110 identifies objects in the operating environment 102 of the farming machine 100. To do so, the detection mechanism 110 obtains information describing the environment 102 (e.g., sensor or image data), and processes that information to identify pertinent objects (e.g., plants 104, substrate 106, persons, etc.) in the operating environment 102. Identifying objects in the environment 102 further enables the farming machine 100 to implement farming actions in the field 160. For example, the detection mechanism 110 may capture an image of the field 160 and process the image with a plant identification module to identify plants 104 in the captured image. The farming machine 100 then implements farming actions in the field 160 based on the plants 104 identified in the image.

The farming machine 100 can include any number or type of detection mechanism 110 that may aid in determining and implementing farming actions. In some embodiments, the detection mechanism 110 includes one or more sensors. For example, the detection mechanism 110 can include a multispectral camera, a stereo camera, a CCD camera, a single lens camera, a CMOS camera, hyperspectral imaging system, LIDAR system (light detection and ranging system), a depth sensing system, dynamometer, IR camera, thermal camera, humidity sensor, light sensor, temperature sensor, or any other suitable sensor. Further, the detection mechanism 110 may include an array of sensors (e.g., an array of cameras) configured to capture information about the environment 102 surrounding the farming machine 100. For example, the detection mechanism 110 may include an array of cameras configured to capture an array of pictures representing the environment 102 surrounding the farming machine 100. The detection mechanism 110 may also be a sensor that measures a state of the farming machine 100. For example, the detection mechanism 110 may be a speed sensor, a heat sensor, or some other sensor that can monitor the state of a component of the farming machine 100. Additionally, the detection mechanism 110 may also be a sensor that measures components during implementation of a farming action. For example, the detection mechanism 110 may be a flow rate monitor, a grain harvesting sensor, a mechanical stress sensor etc. Whatever the case, the detection mechanism 110 senses information about the operating environment 102 (including the farming machine 100).

A detection mechanism 110 may be mounted at any point on the mounting mechanism 140. Depending on where the detection mechanism 110 is mounted relative to the treatment mechanism 120, one or the other may pass over a geographic area in the field 160 before the other. For example, the detection mechanism 110 may be positioned on the mounting mechanism 140 such that it traverses over a geographic location before the treatment mechanism 120 as the farming machine 100 moves through the field 160. In another example, the detection mechanism 110 is positioned to the mounting mechanism 140 such that the two traverse over a geographic location at substantially the same time as the farming machine 100 moves through the field. Similarly, the detection mechanism 110 may be positioned on the mounting mechanism 140 such that the treatment mechanism 120 traverses over a geographic location before the detection mechanism 110 as the farming machine 100 moves through the field 160. The detection mechanism 110 may be statically mounted to the mounting mechanism 140, or may be removably or dynamically coupled to the mounting mechanism 140. In other examples, the detection mechanism 110 may be mounted to some other surface of the farming machine 100 or may be incorporated into another component of the farming machine 100.

### Verification Mechanism(s)

The farming machine 100 may include a verification mechanism 150. Generally, the verification mechanism 150 records a measurement of the operating environment 102 and the farming machine 100 may use the recorded measurement to verify or determine the extent of an implemented farming action (i.e., a result of the farming action).

To illustrate, consider an example where a farming machine 100 implements a farming action based on a measurement of the operating environment 102 by the detection mechanism 110. The verification mechanism 150 records a measurement of the same geographic area measured by the detection mechanism 110 and where farming machine 100 implemented the determined farming action. The farming machine 100 then processes the recorded measurement to determine the result of the farming action. For example, the verification mechanism 150 may record an image of the geographic region surrounding a plant 104 identified by the detection mechanism 110 and treated by a treatment mechanism 120. The farming machine 100 may apply a treatment detection algorithm to the recorded image to determine the result of the treatment applied to the plant 104.

Information recorded by the verification mechanism 150 can also be used to empirically determine operation parameters of the farming machine 100 that will obtain the desired effects of implemented farming actions (e.g., to calibrate the farming machine 100, to modify treatment plans, etc.). For instance, the farming machine 100 may apply a calibration detection algorithm to a measurement recorded by the farming machine 100. In this case, the farming machine 100 determines whether the actual effects of an implemented farming action are the same as its intended effects. If the effects of the implemented farming action are different than its intended effects, the farming machine 100 may perform a calibration process. The calibration process changes operation parameters of the farming machine 100 such that effects of future implemented farming actions are the same as their intended effects. To illustrate, consider the previous example where the farming machine 100 recorded an image of a treated plant 104. There, the farming machine 100 may apply a calibration algorithm to the recorded image to determine whether the treatment is appropriately calibrated (e.g., at its intended location in the operating environment 102). If the farming machine 100 determines that the farming machine 100 is not calibrated (e.g., the applied treatment is at an incorrect location), the farming machine 100 may calibrate itself such that future treatments are in the correct location. Other example calibrations are also possible.

The verification mechanism 150 can have various configurations. For example, the verification mechanism 150 can be substantially similar (e.g., be the same type of mechanism as) the detection mechanism 110 or can be different from the detection mechanism 110. In some cases, the detection mechanism 110 and the verification mechanism 150 may be one in the same (e.g., the same sensor). In an example configuration, the verification mechanism 150 is positioned distal the detection mechanism 110 relative the direction of travel 115, and the treatment mechanism 120 is positioned there between. In this configuration, the verification mechanism 150 traverses over a geographic location in the operating environment 102 after the treatment mechanism 120 and the detection mechanism 110. However, the mounting mechanism 140 can retain the relative positions of the system components in any other suitable configuration. In some configurations, the verification mechanism 150 can be included in other components of the farming machine 100.

The farming machine 100 can include any number or type of verification mechanism 150. In some embodiments, the verification mechanism 150 includes one or more sensors. For example, the verification mechanism 150 can include a multispectral camera, a stereo camera, a CCD camera, a single lens camera, a CMOS camera, hyperspectral imaging system, LIDAR system (light detection and ranging system), a depth sensing system, dynamometer, IR camera, thermal camera, humidity sensor, light sensor, temperature sensor, or any other suitable sensor. Further, the verification mechanism 150 may include an array of sensors (e.g., an array of cameras) configured to capture information about the environment 102 surrounding the farming machine 100. For example, the verification mechanism 150 may include an array of cameras configured to capture an array of pictures representing the operating environment 102.

### Treatment Mechanism(s)

The farming machine 100 may include a treatment mechanism 120. The treatment mechanism 120 can implement farming actions in the operating environment 102 of a farming machine 100. For instance, a farming machine 100 may include a treatment mechanism 120 that applies a treatment to a plant 104, a substrate 106, or some other object in the operating environment 102. More generally, the farming machine 100 employs the treatment mechanism 120 to apply a treatment to a treatment area 122, and the treatment area 122 may include anything within the operating environment 102 (e.g., a plant 104 or the substrate 106). In other words, the treatment area 122 may be any portion of the operating environment 102.

When the treatment is a plant treatment, the treatment mechanism 120 applies a treatment to a plant 104 in the field 160. The treatment mechanism 120 may apply treatments to identified plants or non-identified plants. For example, the farming machine 100 may identify and treat a specific plant (e.g., plant 104) in the field 160. Alternatively, or additionally, the farming machine 100 may identify some other trigger that indicates a plant treatment and the treatment mechanism 120 may apply a plant treatment. Some example plant treatment mechanisms 120 include: one or more spray nozzles, one or more electromagnetic energy sources (e.g., a laser), one or more physical implements configured to manipulate plants, but other plant 104 treatment mechanisms 120 are also possible.

Additionally, when the treatment is a plant treatment, the effect of treating a plant 104 with a treatment mechanism 120 may include any of plant necrosis, plant growth stimulation, plant portion necrosis or removal, plant portion growth stimulation, or any other suitable treatment effect. Moreover, the treatment mechanism 120 can apply a treatment that dislodges a plant 104 from the substrate 106, severs a plant 104 or portion of a plant 104 (e.g., cutting), incinerates a plant 104 or portion of a plant 104, electrically stimulates a plant 104 or portion of a plant 104, fertilizes or promotes growth (e.g., with a growth hormone) of a plant 104, waters a plant 104, applies light or some other radiation to a plant 104, and/or injects one or more working fluids into the substrate 106 adjacent to a plant 104 (e.g., within a threshold distance from the plant). Other plant treatments are also possible. When applying a plant treatment, the treatment mechanisms 120 may be configured to spray one or more of: an herbicide, a fungicide, insecticide, some other pesticide, or water.

When the treatment is a substrate treatment, the treatment mechanism 120 applies a treatment to some portion of the substrate 106 in the field 160. The treatment mechanism 120 may apply treatments to identified areas of the substrate 106, or non-identified areas of the substrate 106. For example, the farming machine 100 may identify and treat an area of substrate 106 in the field 160. Alternatively, or additionally, the farming machine 100 may identify some other trigger that indicates a substrate 106 treatment and the treatment mechanism 120 may apply a treatment to the substrate 106. Some example treatment mechanisms 120 configured for applying treatments to the substrate 106 include: one or more spray nozzles, one or more electromagnetic energy sources, one or more physical implements configured to manipulate the substrate 106, but other substrate 106 treatment mechanisms 120 are also possible.

Of course, the farming machine 100 is not limited to treatment mechanisms 120 for plants 104 and substrates 106. The farming machine 100 may include treatment mechanisms 120 for applying various other treatments to objects in the field 160. Depending on the configuration, the farming machine 100 may include various numbers of treatment mechanisms 120 (e.g., 1, 2, 5, 20, 60, etc.). A treatment mechanism 120 may be fixed (e.g., statically coupled) to the mounting mechanism 140 or attached to the farming machine 100. Alternatively, or additionally, a treatment mechanism 120 may be movable (e.g., translatable, rotatable, etc.) on the farming machine 100. In one configuration, the farming machine 100 includes a single treatment mechanism 120. In this case, the treatment mechanism 120 may be actuatable to align the treatment mechanism 120 to a treatment area 122. In a second variation, the farming machine 100 includes a treatment mechanism 120 assembly comprising an array of treatment mechanisms 120. In this configuration, a treatment mechanism 120 may be a single treatment mechanism 120, a combination of treatment mechanisms 120, or the treatment mechanism 120 assembly. Thus, either a single treatment mechanism 120, a combination of treatment mechanisms 120, or the entire assembly may be selected to apply a treatment to a treatment area 122. Similarly, either the single, combination, or entire assembly may be actuated to align with a treatment area, as needed. In some configurations, the farming machine 100 may align a treatment mechanism 120 with an identified object in the operating environment 102. That is, the farming machine 100 may identify an object in the operating environment 102 and actuate the treatment mechanism 120 such that its treatment area aligns with the identified object.

A treatment mechanism 120 may be operable between a standby mode and a treatment mode. In the standby mode the treatment mechanism 120 does not apply a treatment, and in the treatment mode the treatment mechanism 120 is controlled by the control system 130 to apply the treatment. However, the treatment mechanism 120 can be operable in any other suitable number of operation modes.

### Control System(s)

The farming machine 100 includes a control system 130. The control system 130 controls operation of the various components and systems on the farming machine 100. For instance, the control system 130 can obtain information about the operating environment 102, processes that information to identify a farming action, and implement the identified farming action with system components of the farming machine 100.

The control system 130 can receive information from the detection mechanism 110, the verification mechanism 150, the treatment mechanism 120, and/or any other component or system of the farming machine 100. For example, the control system 130 may receive measurements from the detection mechanism 110 or verification mechanism 150, or information relating to the state of a treatment mechanism 120 or implemented farming actions from a verification mechanism 150. Other information is also possible.

Similarly, the control system 130 can provide input to the detection mechanism 110, the verification mechanism 150, and/or the treatment mechanism 120. For instance, the control system 130 may be configured to input and control operating parameters of the farming machine 100 (e.g., speed, direction). Similarly, the control system 130 may be configured to input and control operating parameters of the detection mechanism 110 and/or verification mechanism 150. Operating parameters of the detection mechanism 110 and/or verification mechanism 150 may include processing time, location and/or angle of the detection mechanism 110, image capture intervals, image capture settings, etc. Other inputs are also possible. Finally, the control system may be configured to generate machine inputs for the treatment mechanism 120. That is translating a farming action of a treatment plan into machine instructions implementable by the treatment mechanism 120.

The control system 130 can be operated by a user operating the farming machine 100, wholly or partially autonomously, operated by a user connected to the farming machine 100 by a network, or any combination of the above. For instance, the control system 130 may be operated by an agricultural manager sitting in a cabin of the farming machine 100, or the control system 130 may be operated by an agricultural manager connected to the control system 130 via a wireless network. In another example, the control system 130 may implement an array of control algorithms, machine vision algorithms, decision algorithms, etc. that allow it to operate autonomously or partially autonomously.

The control system 130 may be implemented by a computer or a system of distributed computers. The computers may be connected in various network environments. For example, the control system 130 may be a series of computers implemented on the farming machine 100 and connected by a local area network. In another example, the control system 130 may be a series of computers implemented on the farming machine 100, in the cloud, a client device and connected by a wireless area network.

The control system 130 can apply one or more computer models to determine and implement farming actions in the field 160. For example, the control system 130 can apply a plant identification model to images acquired by the detection mechanism 110 to determine and implement farming actions. The control system 130 may be coupled to the farming machine 100 such that an operator (e.g., a driver) can interact with the control system 130. In other embodiments, the control system 130 is physically removed from the farming machine 100 and communicates with system components (e.g., detection mechanism 110, treatment mechanism 120, etc.) wirelessly.

In some configurations, the farming machine 100 may additionally include a communication apparatus, which functions to communicate (e.g., send and/or receive) data between the control system 130 and a set of remote devices. The communication apparatus can be a Wi-Fi communication system, a cellular communication system, a short-range communication system (e.g., Bluetooth, NFC, etc.), or any other suitable communication system.

### Other Machine Components

In various configurations, the farming machine 100 may include any number of additional components.

For instance, the farming machine 100 may include a mounting mechanism 140. The mounting mechanism 140 provides a mounting point for the components of the farming machine 100. That is, the mounting mechanism 140 may be a chassis or frame to which components of the farming machine 100 may be attached but could alternatively be any other suitable mounting mechanism 140. More generally, the mounting mechanism 140 statically retains and mechanically supports the positions of the detection mechanism 110, the treatment mechanism 120, and the verification mechanism 150. In an example configuration, the mounting mechanism 140 extends outward from a body of the farming machine 100 such that the mounting mechanism 140 is approximately perpendicular to the direction of travel 115. In some configurations, the mounting mechanism 140 may include an array of treatment mechanisms 120 positioned laterally along the mounting mechanism 140. In some configurations, the farming machine 100 may not include a mounting mechanism 140, the mounting mechanism 140 may be alternatively positioned, or the mounting mechanism 140 may be incorporated into any other component of the farming machine 100. Additionally, the mounting mechanism 140 may be utilized for removably coupling various components of the farming machine 100. For example, the mounting mechanism 140 may be used to removably couple a detection mechanism from the farming machine.

The farming machine 100 may include locomoting mechanisms. The locomoting mechanisms may include any number of wheels, continuous treads, articulating legs, or some other locomoting mechanism(s). For instance, the farming machine 100 may include a first set and a second set of coaxial wheels, or a first set and a second set of continuous treads. In either example, the rotational axis of the first and second set of wheels/treads are approximately parallel. Further, each set is arranged along opposing sides of the farming machine 100. Typically, the locomoting mechanisms are attached to a drive mechanism that causes the locomoting mechanisms to translate the farming machine 100 through the operating environment 102. For instance, the farming machine 100 may include a drive train for rotating wheels or treads. In different configurations, the farming machine 100 may include any other suitable number or combination of locomoting mechanisms and drive mechanisms.

The farming machine 100 may also include one or more coupling mechanisms 142 (e.g., a hitch). The coupling mechanism 142 functions to removably or statically couple various components of the farming machine 100. For example, a coupling mechanism may attach a drive mechanism to a secondary component such that the secondary component is pulled behind the farming machine 100. In another example, a coupling mechanism may couple one or more treatment mechanisms 120 to the farming machine 100.

The farming machine 100 may additionally include a power source, which functions to power the system components, including the detection mechanism 110, control system 130, and treatment mechanism 120. The power source can be mounted to the mounting mechanism 140, can be removably coupled to the mounting mechanism 140, or can be incorporated into another system component (e.g., located on the drive mechanism). The power source can be a rechargeable power source (e.g., a set of rechargeable batteries), an energy harvesting power source (e.g., a solar system), a fuel consuming power source (e.g., a set of fuel cells or an internal combustion system), or any other suitable power source. In other configurations, the power source can be incorporated into any other component of the farming machine 100.

### III.B System Environment

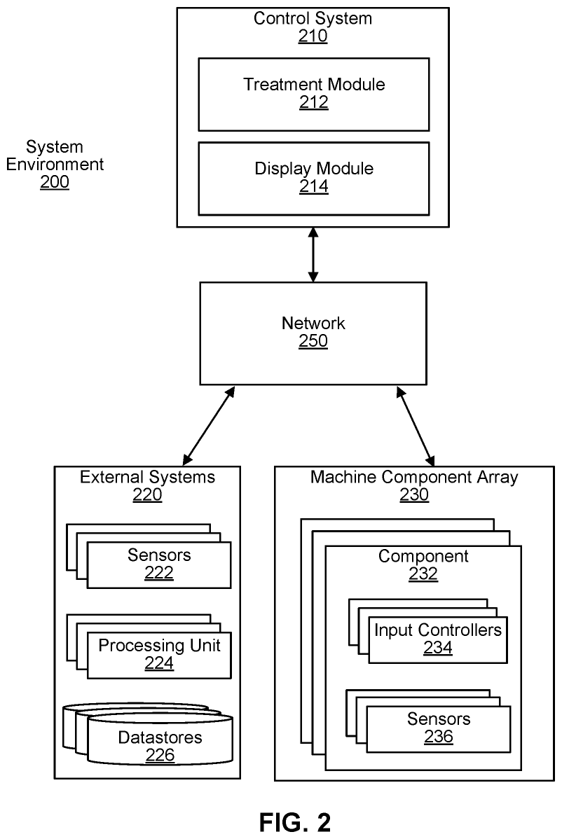

FIG. 2 is a block diagram of the system environment for the farming machine 100, in accordance with one or more example embodiments. In this example, a control system 210 (e.g., control system 130) is connected to external systems 220 and a machine component array 230 via a network 240 within the system environment 200.

The external systems 220 are any system that can generate data used to selecting treatments for plants 104 based on their identification. External systems 220 may include one or more sensors 222, one or more processing units 224, and one or more datastores 226. The one or more sensors 222 can measure the field 160, the operating environment 102, the farming machine 100, etc. and generate data representing those measurements. For instance, the sensors 222 may include a rainfall sensor, a wind sensor, heat sensor, a camera, etc. The processing units 2240 may process measured data to provide additional information that may aid in selecting treatments for plants 104. For instance, a processing unit 224 may access an image of a field 160 and calculate a weed pressure from the image or may access historical weather information for a field 160 to generate a forecast for the field. Datastores 226 store historical information regarding the farming machine 100, the operating environment 102, the field 160, etc. that may be beneficial in selecting treatments for plants 104 in the field 160. For instance, the datastore 226 may store results of previously implemented treatment plans and farming actions for a field 160, a nearby field, and or the region. The historical information may have been obtained from one or more farming machines (i.e., measuring the result of a farming action from a first farming machine with the sensors of a second farming machine). Further, the datastore 226 may store results of specific farming actions in the field 160, or results of farming actions taken in nearby fields having similar characteristics. The datastore 226 may also store historical weather, flooding, field use, planted crops, etc. for the field and the surrounding area. Finally, the datastores 226 may store any information measured by other components in the system environment 200.

The machine component array 230 includes one or more components 232. Components 222 are elements of the farming machine 100 that can take farming actions (e.g., a treatment mechanism 120). As illustrated, each component has one or more input controllers 234 and one or more sensors 236, but a component may include only sensors 236 or only input controllers 234. An input controller 234 controls the function of the component 232. For example, an input controller 234 may receive machine commands via the network 240 and actuate the component 232 in response. A sensor 236 generates data representing measurements of the operating environment 102 and provides that data to other systems and components within the system environment 200. The measurements may be of a component 232, the farming machine 100, the operating environment 102, etc. For example, a sensor 236 may measure a configuration or state of the component 232 (e.g., a setting, parameter, power load, etc.), measure conditions in the operating environment 102 (e.g., moisture, temperature, etc.), capture information representing the operating environment 102 (e.g., images, depth information, distance information), and generate data representing the measurement(s). One or more of the sensors 236 may include one or more cameras.

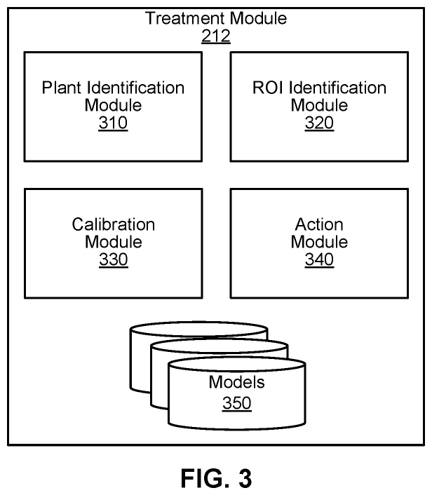

The control system 210 receives information from external systems 220 and the machine component array 230 and implements a treatment plan in the field 160 with the farming machine 100. Additionally, the control system 210 employs a treatment module 212 to identify and calibrate a region of interest on the ground surface of a field to facilitate implementation of a treatment plan and/or farming objective. To do so, the treatment module 212 may process images of plants in the field, calibrate and identify regions of interest in the images based on the brightness of the image, identify plants in those regions of interests, and generate instructions for components of the farming machine to perform a treatment on the identified plants. Determining a region of interest can be done in substantially real-time as the farming machine 100 is moving through a field, or after a calibration of the region of interest before the farming machine 100 begins an automated movement through the field. The treatment module 212 is described in greater detail with respect to FIG. 3.

The network 240 connects nodes of the system environment 200 to allow microcontrollers and devices to communicate with each other. In some embodiments, the components are connected within the network as a Controller Area Network (CAN). In this case, within the network each element has an input and output connection, and the network 240 can translate information between the various elements. For example, the network 240 receives input information from the component array 230, processes the information, and transmits the information to the control system 210. The control system 210 generates a farming action based on the information and transmits instructions to implement the farming action to the appropriate component(s) 232 of the component array 230.

Additionally, the system environment 200 may be other types of network environments and include other networks, or a combination of network environments with several networks. For example, the system environment 200, can be a network such as the Internet, a LAN, a MAN, a WAN, a mobile wired or wireless network, a private network, a virtual private network, a direct communication line, and the like.

### III. Treatment Using Real-Time Identification of a Region of Interest

The treatment module 212 of the control system 210 is configured to calibrate the performance characteristics of a farming machine 100 as the farming machine 100 travels through the field. FIG. 3 illustrates an example of the treatment module 212, according to one example embodiment. The treatment module 212 includes a plant identification module 310, a ROI identification module 320, a calibration module 330, an action module 340, and models 350. The treatment module 212 may include additional or fewer modules, and the functionality of a module may be attributable to a different module. Moreover, the various functionalities of the treatment module 212 may be attributable to different components and systems within the environment 200.

The treatment module 212 includes a plant identification module 310. The control system 130 employs the plant identification module 310 to identify plants in images captured by a detection mechanism 110. The plant identification module 310 identifies plant by applying one or more of the models 350 trained to identify plant to the images. The farming machine 100 treats plants identified in images using a treatment mechanism 120. The plant identification module 310 may determine a plant within an identified ROI. In some embodiments, the plant identification module 310 may implement one or more thresholds for classifying a plant (e.g., as a crop or not, as a weed or not, etc.). The plant identification module 310 may vary the thresholds in substantially real-time as the autonomous farming machine is traveling through the field based on a brightness level of one or more image pixels. For example, the plant identification module 310 may increase the accuracy threshold for weed classification in response to determining that the plant under investigation is depicted by pixels having an above-threshold detected brightness level. In some embodiments, the plant identification module 310 may generate an analysis flag for a plant in response to detecting, with an accuracy below a particular level, that the plant is a weed. The plant identification module 310 can generate the analysis flag to cause the autonomous farming machine to reanalyze the plant during the daytime or whenever there is a sufficient amount of light to meet a brightness level threshold. The analysis flag may include a measured location of the plant in the field.

The plant identification module 310 may apply different types of models 350 to images to identify plants, some of which are described hereinbelow. In a first example, the plant identification module 310 applies a semantic segmentation model to an image to identify plants in the image. The segmentation model may be a convolutional neural network including an input layer, a latent layer, an output layer, and intermediate layers that, in aggregate, are trained to identify plants in images.

To identify plants in an image using the segmentation model, the plant identification module 310 encodes an image onto an input layer of the convolutional neural network and applies various functions, weights, and parameters using intermediate layers to reduce the dimensionality of the image on the input layer to that of the latent layer. Within the latent layer, the convolutional neural network is trained to recognize latent information in the encoded information representing plants. The plant identification module 310 decodes information from the latent layer to the output layer. Decoding the information may include applying various functions, weights, and parameters using intermediate layers. At the output layer, each pixel of the input image is labelled as representing plant. Pixels may be up-sampled or down-sampled throughout the model process depending on the configuration of the segmentation model.

In some configurations, each pixel corresponds to a probability that the pixel represents a plant (e.g., one pixel has a 65% chance of representing a plant, while another pixel has a 92% chance of representing a plant). The plant identification module 310 may then identify plants in the image based on the labels and/or their corresponding probabilities. For example, the plant identification module 310 identifies a plant as a group of pixels labelled as a plant and having a high probability the pixels represent a plant. The farming machine 100 treats plants identified in the image. For example, the farming machine treats the plant by applying a treatment with a treatment mechanism 120 at the location in the field corresponding to pixels identified as the plant in the image.

An example segmentation model is described in U.S. Pat. No. 11,514,671, titled “Segmentation for Plant Treatment and Treatment Verification,” filed Jun. 4, 2020, which is hereby incorporated by reference in its entirety.

In a second example, the plant identification module 310 applies a bounding box model to an image to identify plants. The bounding box model is trained to identify two-dimensional regions in an image that contain pixels representing a plant (rather than labelling individual pixels as representing plants). In some configurations, the bounding box model places a box around the two-dimensional regions, and/or generates a probability that the boxed pixels represent a plant. The plant identification module 310 identifies plants in the image using the boxed pixels and their associated probabilities (e.g., pixels in this box have a 48% chance of representing a plant, while pixels in this box have an 81% chance of representing a plant). The farming machine 100 treats plants in the field based on plants identified in bounding boxes.

An example bounding box model is described in U.S. Pat. No. 11,093,745, titled “Automated plant detection using image data,” filed May 9, 2018, which is hereby incorporated by reference in its entirety.

Different models 350 employed by the plant identification module 310 may also be configured to identify plants using variable plant identification sensitivities. A plant identification sensitivity is a parameter of a model 350 quantifying how “sensitive” the model 350 is when identifying plants, with high-sensitivity models identifying more visual information in an image (e.g., pixels) as a plant and low-sensitivity models identifying less visual information in an image as plants. Any number of sensitivity levels are possible (e.g., 1, 2, 3, 5, 10, etc.).

To illustrate, consider a model 350 configured to identify plants with either a high plant identification sensitivity or a low plant identification sensitivity when applied to an image. The farming machine 100 captures an image of a plant in the field. The image includes green pixels representing the plant, brown pixels representing the substrate, and green-brown pixels that may represent either the plant or the substrate. For both high and low sensitivity, the plant identification module 310 identifies green pixels as representing plants and brown pixels as representing substrate. However, the plant identification module 310 identifies the green-brown pixels as a plant when using the high plant identification sensitivity (because the pixel might represent plant) and identifies the green-brown pixels as substrate when using the low plant identification sensitivity (because the pixel might represent the substrate).

In some configurations, each plant identification sensitivity may correspond to a probability that a pixel (or group of pixels) represents a plant. For instance, the plant identification module 310 may employ a model 350 trained to output a probability value between 0.0 and 1.0 that each pixel (or group of pixels) represents a plant, where 0.0 represents an improbable plant and 1.0 represents a probable plant. Within this framework, a high plant identification sensitivity may identify any pixel having a probability above, e.g., 0.65 as a plant, while a low plant identification sensitivity may identify any pixel having a probability above, e.g., 0.80 as a plant. Because the probability threshold for the high plant identification sensitivity is lower than the threshold for the low plant identification sensitivity, the plant identification module 310 will identify more pixels representing plants using the high plant identification sensitivity compared to using the low plant identification sensitivity.

In some configurations, each plant identification sensitivity level may correspond to particular performance characteristics. That is, a model 350 employing a first plant identification sensitivity may have a first set of performance characteristics, a second plant identification sensitivity may have a second set of performance characteristics, etc. Because of this, a farming machine 100 may be able to determine a plant identification sensitivity to achieve a target performance characteristic. For instance, consider a farming machine 100 employing a model 350 to identify plants at a first plant sensitivity. The farming machine 100 achieves the first set of performance characteristics. The farming machine 100 then receives a target performance characteristic that is the same as (or similar to, e.g., within 2%, 5%, 10% etc.) a performance characteristic having a corresponding plant identification sensitivity. In turn, the farming machine 100 may automatically implement the plant identification sensitivity to achieve the target performance characteristic or recommend that a manager implement the corresponding plant identification sensitivity.

Models 350 applied by the plant identification module 310 may also be a multi-classifier model capable of identifying various classes of objects in an image. For instance, plant identification module 310 may be configured to identify substrate, obstructions, humans, components, plants, or other objects in the image. Moreover, the models 350 may be capable of distinguishing between the types of objects. For instance, the plant identification module 310 may employ a model 350 capable of identifying plants as weeds or crops, and further capable of determining the species of each distinct weed and/or crop.

A multi-classifier model trained to identify different types and species of plants is described in described in U.S. patent application Ser. No. 16/995,618, titled “Plant Group Identification,” filed on Aug. 17, 2020. The model described therein may be configured with additional labels.

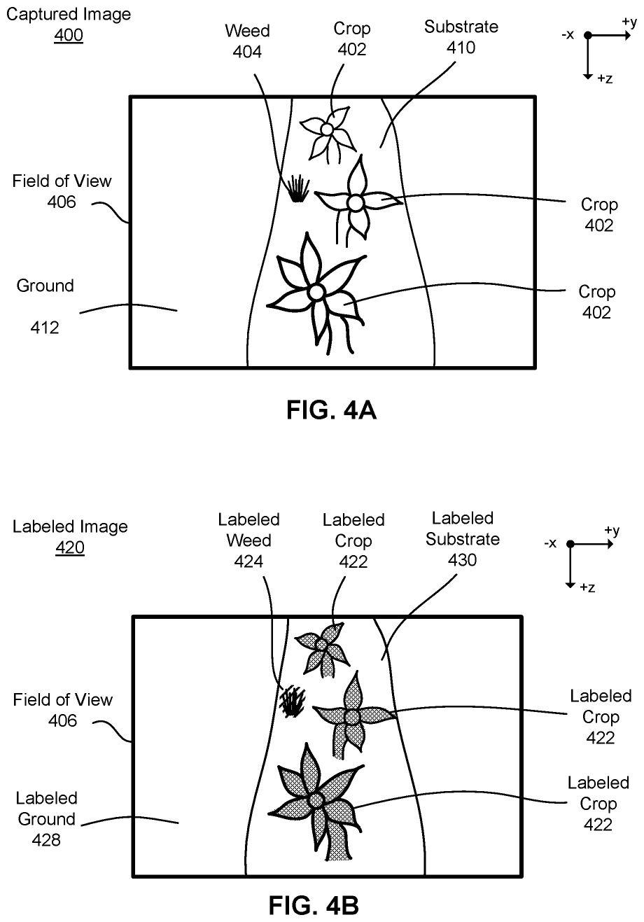

The control system 210 may employ a plant identification module 310 to apply one or more models 350 to an image captured by the farming machine 100 as it travels through the field to treat plants. FIGS. 4A and 4B illustrate an example embodiment of this process. Importantly, features of the various models 350 described herein can be combined to generate a model 350 appropriate for the farming objective and farming actions of the farming machine 100. For instance, the farming machine 100 may employ a multi-class classifier trained to identify different types and species of plants in an image, and the classifier may be configured to identify plants in images at a variety of plant identification sensitivities. Moreover, this model may be configured to identify crops with a first plant identification sensitivity and weeds with a second, different plant identification sensitivity.

FIG. 4A illustrates an accessed image of the field captured by the farming machine, according to one example embodiment. The accessed image 400 of the field (e.g., field 160) includes various plants and the ground within the field of view 406. The plants include multiple crops 402 and a weed 404 growing on a substrate 410. In some examples (not pictured), the image 400 also includes visual information representing one or more machine components, the sky, persons, obstacles, animals, or any other objects pertinent to the environment.

FIG. 4B illustrates a labeled image of the field, according to one example embodiment. To generate the labeled image 420, the farming machine 100 employs the plant identification module 310 to apply one or more models 350 to the accessed image. The plant identification module 310 processes the visual information (e.g., one or more pixels in the accessed image 400) to determine the real-world object(s) that visual information represents. For example, the labeled image 420 includes labeled crops 422, a labeled weed 424, the labeled ground 428, and the labeled substrate 430, each of which corresponds to pixels whose visual information represents the crops 402, the weed 404, the ground 412, and the substrate 410, respectively. Pixels in the labeled image 420 labeled as the weed 424 have a first fill pattern, and pixels in the labeled image 420 labeled as a crop 422 has a second fill pattern. For clarity, pixels in the labeled image 420 labeled as substrate 430 and ground remain unfilled 528. Additionally, the labeled visual information is overlaid on the captured image, though it need not be.

The ROI identification module 320 identifies a region of interest of a ground surface of a field through which an autonomous farming machine travels. In one example, the ROI identification module 320 may process images of a ground surface in front of a boom of an autonomous farming machine. The ROI identification module 320 may process the images by determining brightness levels at various pixels of the images and comparing the brightness level to a threshold brightness level. The ROI identification module 320 may determine an ROI corresponding to a portion of the ground surface in front of the boom corresponding to an above-threshold detected brightness level.

The ROI identification module 320 may receive images of the ground surface from one or more cameras coupled to the autonomous farming machine. The one or more cameras may be attached to the autonomous farming machine (e.g., attached to the sun shield and facing the front of the autonomous farming machine), located externally and communicatively coupled to the autonomous farming machine (e.g., a camera of a drone traveling alongside the machine and communicatively coupled via a wireless network), or a combination thereof.

The ground surface captured in the images may be lit by one or more light sources. The one or more light sources may be attached to the autonomous farming machine, located externally (e.g., integrated into the assembly of a drone traveling alongside the machine), or a combination thereof. The autonomous farming machine may include a boom, which may include one or more light sources (“lights”) configured to illuminate the ground surface in front of the boom. The one or more lights may be configured to illuminate the ground surface in front of the autonomous farming machine by being positioned at a particular angle. The one or more lights may be angled manually or automatically. The one or more lights may be angled during a calibration stage, which may be performed by the calibration module 330. The one or more lights may be angled automatically using instructions generated by the action module 340 based on calibration results generated by the calibration module 330. In some embodiments, two or more lights may be mounted on a mounting mechanism (e.g., a boom) with a pre-defined distance between each light.

The ROI identification module 320 may detect a brightness level at each of one or more points of a ground surface in front of a boom of the autonomous farming machine. The ROI identification module 320 may process one or more images of the ground surface to determine the brightness level at each of the one or more points. The ROI identification module 320 may process each image along multiple dimensions. For example, the ROI identification module 320 may determine the brightness of image pixels by iterating columns of image pixels, and through each column of image pixels, iterating through brightness values of pixel rows. In this way, the ROI identification module 320 may partition an image along a first dimension (e.g., columns along the x-axis of the image) and for each partition, determine the brightness level of image pixels along a second dimension of the image (e.g., along the y-axis of the image). One or more points of the ground surface may be represented by respective pixels or a combination of the pixels (e.g., a group of pixels depicting a point on the ground surface).

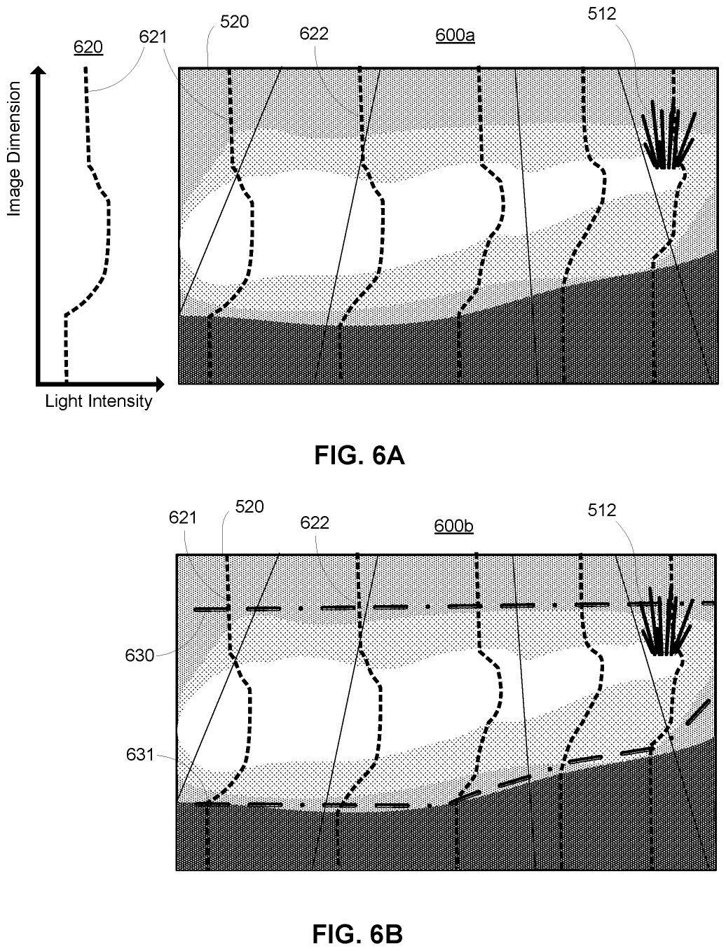

The ROI identification module 320 may identify an ROI corresponding to a portion of the ground surface in front of the boom corresponding to an above-threshold detected brightness level. In some embodiments, identifying the ROI includes determining a region within an image of the ground surface in front of the boom, where the region includes pixels having a brightness above a threshold brightness level. This brightness may be referred to as an above-threshold detected brightness level. To determine the region within the image that includes pixels having a brightness above a threshold brightness level, the ROI identification module 320 may determine boundary lines that bound the ROI. The ROI identification module 320 may determine pixels of a boundary line by traversing the image along one dimension (e.g., along a column of an image) and determining two or more pixels whose brightness values transition to surpass or fall below the threshold brightness level. One example of boundary lines is depicted in FIG. 6B.

In some embodiments, the ROI includes a fixed area. In one example, the ROI may be trapezoidal in shape, having a fixed height and fixed area. The ROI identification module 320 may determine a portion of an image of the ground surface in front of the autonomous farming machine having an above-threshold brightness level that may be bounded by the trapezoidal ROI. The ROI may be any suitable shape for bounding the portion of an image of a ground surface that is lit at an above-threshold brightness level. In some embodiments, the shape of the ROI may dynamically change depending on the brightness level of the ground. For example, as the autonomous farming machine is traveling, the ROI identification module 320 may determine a first ROI corresponding to a first portion of a first image that depicts a region of the ground surface at the above-threshold brightness level, where the first ROI is trapezoidal in shape having a first height and a first area. As the autonomous farming machine travels, one or more light sources may dislocate, causing a second image of the ground surface, taken subsequently to the first image, to depict a region of the ground surface that is lit differently from the first image. To account for the differently lit surface, the ROI identification module 320 may identify a second ROI having a second height and the same first area.

The ROI identification module 320 may transform an identified ROI having a first shape into an image of an ROI having a second shape. For example, cameras taking photos of the ground surface in front of the autonomous farming machine may be directed at an angle relative to the ground that is between forty to seventy degrees. Images taken from the camera are not at an overhead angle (e.g., within five degrees from a ninety degree angle above the ground surface depicted). The ROI identification module 320 may transform an identified ROI, having a trapezoidal shape, from the camera images to create a new image of the identified ROI, where the new image depicts the identified ROI in a rectangular shape rather than a trapezoidal shape. The ROI identification module 320 may transform the trapezoidal ROI's into rectangular ROI's depicted from a consistent overhead angle (e.g., providing depictions of the ground surface as if captured by a camera at substantially ninety degrees from the ground). In some embodiments, the ROI identification module 320 may determine a portion of an ROI that is not sufficiently lit (e.g., image pixels having brightness values below the threshold brightness level). In response, the ROI identification module 320 may perform image processing to brighten that portion of the image of the ROI.

The calibration module 330 calibrates ROI's for varying light and/or camera locations. The calibration module 330 may calibrate before an autonomous farming machine begins traveling through a field, while the autonomous farming machine is traveling through the field, or a combination thereof. The calibration module 330 may determine that an ROI with sufficiently lit ground surface cannot be identified (e.g., due to an improperly positioned or dislocated camera or light source) and provide instructions to the action module 340 to generate a notification accordingly, adjust the positioning of one or more of a camera or light source, pause the movement of the autonomous farming machine, or a combination thereof.

The calibration module 330 may determine a position of an ROI within an image frame and/or shape of an ROI for each of multiple heights and/or angles at which a camera capturing the ground surface in front of an autonomous farming machine may be configured. A height sensor of the autonomous farming machine that is coupled to the camera may provide the height of the camera to the calibration module 330. The calibration module 330 may request that the ROI identification module 320 identify an ROI at the measured height and store the pixel coordinates of the identified ROI in a database, the stored ROI coordinates mapped to the measured height. The ROI identification module 320 may access the database for this calibrated ROI as the autonomous farming machine travels, and the action module 340 may perform treatments accordingly. In response to determining that the calibrated ROI does not depict a portion of the ground at the above-threshold brightness level, the calibration module 330 may re-calibrate the ROI.

The calibration module 330 may, for each of one or more heights at which the boom is configurable, identify a respective ROI associated with the boom configured at the height. Respective ROI's can correspond to a respective portion of the ground surface in front of the boom, where the respective portion corresponds to the above-threshold detected brightness level (e.g., the image of the respective portion includes pixels having at least a threshold brightness). For example, as the autonomous farming machine moves in the field, the boom may move up and down, causing the height from the ground of components attached to the boom to change. The calibration module 330 may calibrate ROI's for different light source heights, camera heights, or a combination thereof. The calibration module 330 may store the calibrated ROI's and query for a stored ROI using a measured height of a light source and/or camera.

The calibration module 330 may determine in substantially real-time as an autonomous farming machine travels through a field, that an ROI is outside of a calibrated location. A calibrated ROI location may be characterized by parameters such as image properties and environmental context. An image property parameter may include one or more pixel coordinates defining a location of an ROI, an average brightness value of pixels of the image, a minimum and/or maximum brightness value of pixels, an average contrast value of pixels, a type of camera used, a unique identifier of the camera used, any suitable characteristic of an image of the ground surface, or a combination thereof. An environment context parameter may include a time of day, a location coordinate (e.g., GPS coordinate), a weather type, a type of plant, a unique identifier of the autonomous farming machine, any suitable characteristic of the environment in which the image is captured, or a combination thereof. The calibration module 330 may be used when the autonomous farming machine is operated at night or when natural light is insufficient to light the ground surface in front of an autonomous farming machine to determine that lights attached to the autonomous farming machine (e.g., to the boom) are mislocated. Lights may be mislocated due to the angle of the light source, a broken or switched off light (e.g., in an array of lights), any suitable defect that impacts an amount of light to which the ground surface is exposed to, or combination thereof.

The calibration module 330 may determine a mislocated light based on a brightness level of a portion of the ground surface. The calibration module 330 may determine a number of points of the ground surface in front of the boom having a brightness level at an above-threshold detected rightness level. The calibration module 330 may then determine, based on the number of points, whether one or more lights used to illuminate the ground surface in front of the boom is illuminating at the above-threshold detected brightness level. In some embodiments, the calibration module 330 may use a threshold percentage of an ROI area to determine whether enough of the ROI is illuminated above the brightness level threshold. For example, the calibration module 330 may receive a user specified threshold percentage of seventy percent, and the calibration module 330 may determine whether the percentage of pixels of the ROI having a brightness value at the above-threshold detected brightness level satisfies the threshold percentage.

In response to the calibration module 330 determining that the one or more lights is illuminating the ground surface in front of the boom below the above-threshold detected brightness level, the calibration module 330 can generate a notification that the one or more lights are mislocated (e.g., are mounted at an incorrect angle). The action module 340 may send the generated notification to a remote device or service (e.g., to a computer at a control station monitoring the autonomous farming machine). Additionally or alternatively, the action module 340 may perform remedial actions such as adjusting the angle of a light (e.g., automatically or via instructions received from a manual user input). The calibration module 330 may subsequently determine whether a threshold percentage of the ROI in an image captured subsequent to the remedial action of the ground surface in front of the boom has been met.

The action module 340 may generate instructions to actuate components of the autonomous farming machine. The action module 340 may select an action based on the detected plant. For example, the action module 340 may select to spray herbicide based on a detected weed. In another example, the action module 340 may select to spray fertilizer based on a detected crop. The action module 340 may perform the selected action at a delayed time based on a location of the ROI. For example, the action module 340 may generate instructions for performing the spray of fertilizer at five seconds after the crop was initially identified by the plant identification module 310. By determining a delay, the action module 340 allows for the autonomous farming machine to account for the spatial distance between the identified plant in the ROI ahead of the boom and the location of the autonomous farming machine component that executes the treatment (e.g., a nozzle for dispensing fertilizer located behind the boom).

The action module 340 may receive sensor measurements (e.g., height of the camera and speed of the autonomous farming machine) and position measurements of the components (e.g., angle of the camera relative to the ground, distance between the treatment execution component and the camera, etc.) to determine the delay for executing the treatment. The action module 340 may determine a location of the ROI by determining a distance between the ROI and the camera. The action module 340 may use the angle of the camera (e.g., the angle that the camera is adjusted to capture the ground surface in front of the boom) and the height of the camera to determine a distance between the ROI and the camera. The action module 340 may then determine the delayed time based on a measured speed of the autonomous farming machine and the determined location of the ROI (e.g., the distance between the ROI and the camera).

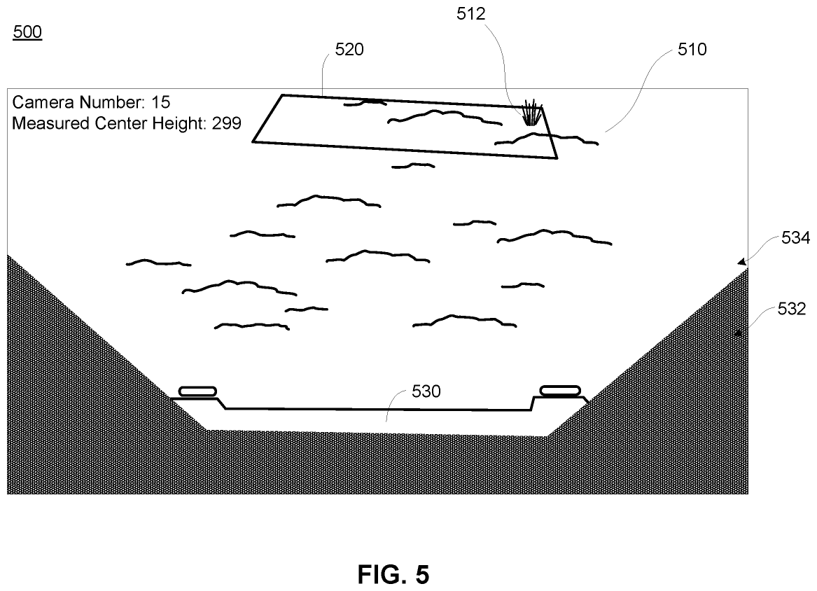

FIG. 5 depicts an ROI identification view 500 of a ground surface in front of an autonomous farming machine 530, according to one embodiment. The autonomous farming machine 530 may travel through a field 510 during the night. One or more lights coupled to the autonomous farming machine 530 (e.g., lights attached to the boom of the autonomous farming machine 530) can light the field 510 in the direction of the travel of the autonomous farming machine 530. The lights create a lit area 534 in front of the autonomous farming machine 530, while images of an unlit area 532 may not be processed by the ROI identification module 320. A camera of the autonomous farming machine 530 may capture images of the ground surface in front of the boom of the autonomous farming machine 530. The camera may be one of multiple cameras attached to the autonomous farming machine 530. The view 500 may be captured by a camera having a number identifier (e.g., “15”) and a measured height (e.g., 299 centimeters). The height may be a center height measured from the ground to the center of the camera. The ROI identification module 320 may determine, using images from the camera, an ROI 520. A weed 512 may be located within the ROI 520.

FIGS. 6A and 6B show light intensity determination views 600a and 600b within the ROI 520 of FIG. 5, according to one embodiment. The view 600a shows light intensities along columns of the image of the ROI 520. The view 600b shows light intensity thresholding applied to the image based on the intensity values along the columns of the view 600a. The views 600a and 600b of the ROI 520 may be generated by the ROI identification module 320. For example, the ROI 520 as depicted in FIG. 5 is trapezoidal in shape, and the ROI identification module 320 may transform the trapezoidal image to a rectangular shape as shown by the views 600a and 600b. In some embodiments, the ROI 520 may be an initially calibrated ROI. For example, the calibration module 330 may determine an initial pixel location for the ROI of camera “15” having a height of 299 centimeters. The ROI 520 depicted in FIG. 5 may be located at the initial pixel location. The calibration module 330 may determine whether a light of the autonomous farming machine 530 is mislocated based on the portion of the ROI 520 that has an above-threshold brightness level. The calibration module 330 may receive brightness level determinations from the ROI identification module 320. The calibration module 330 may use the determined brightness level to determine the portion of the ROI 520 that has an above-threshold brightness level.

FIG. 6A depicts the ROI 520 of FIG. 5, including the weed 512. The view 600a of the ROI 520 includes light intensity lines, including lines 621 and 622, overlaid on the image of the ground surface. Each light intensity line may indicate the brightness of the ground surface along a column of the image. A graph 620 shows the light intensity line 621 plotted according to light intensity on a first axis (e.g., x-axis) and image pixel dimension (e.g., height) on a second axis (e.g., y-axis). As the brightness value of a pixel in an image column increases, the light intensity line shifts in the direction of the increasing first axis. The ROI identification module 320 may calculate the light intensity lines for one or more image columns. In some embodiments, the ROI identification module 320 may partition the image into a number of columns (e.g., equal to or fewer than the image width) and calculate the light intensity at an image height within a column based on one or more pixels having the height (e.g., averaging the brightness value across multiple pixels). The brightness of the ground surface is depicted in FIGS. 6A and 6B through different stippling shades, where the greater the density of stippling refers to a lesser lit surface.

FIG. 6B depicts the ROI 520 with threshold brightness boundary lines 630 and 631 in addition to the superimposed light intensity lines from FIG. 6A. The calibration module 330 may determine the threshold brightness boundary lines 630 and 631 using the light intensity lines (e.g., the lines 621 and 622) determined by the ROI identification module 320. In some embodiments, the calibration module 330 compares the values of a light intensity line to determine one or more locations on the light intensity line where the light intensity value transitions above or below a threshold brightness level. The calibration module 330 may determine points of a threshold brightness boundary line using these determined locations. For example, the calibration module 330 may interpolate a threshold brightness boundary line using determined location of multiple light intensity lines where the light intensity has transitioned from below to above a threshold brightness level.

The calibration module 330 may determine a percentage of the ROI that is at an above-threshold detected brightness level by determining the number of pixels bounded within threshold brightness boundary lines. For example, the calibration module 330 may determine a number of pixels between the brightness boundary lines 630 and 631 and compare the determined number to the total number of pixels. In response to determining that the percentage of pixels between the lines 630 and 631 satisfy a threshold brightness percentage, the calibration module 330 may determine the lights are not mislocated. In response to determining that the percentage of pixels is below the threshold percentage, the calibration module 330 may determine that one or more lights used to illuminate the ground surface in front of the boom is mislocated.

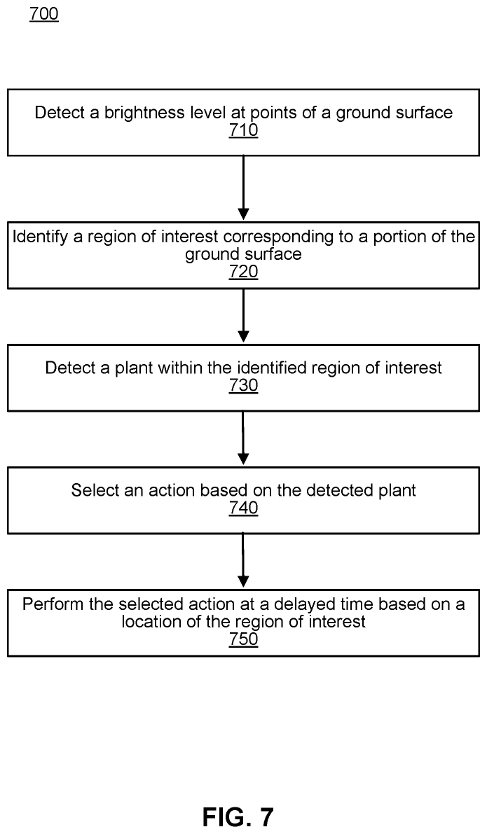

FIG. 7 depicts a process 700 for treating a plant detected in an identified region of interest, according to one embodiment. The process 700 may be performed by the treatment module 212. The process may include additional, fewer, or different operations than shown in FIG. 7.

The treatment module 212 detects 710 a brightness level at points of a ground surface. For example, the ROI identification module 320 may detect 710 a brightness level for each of one or more points of a ground surface in front of a boom of an autonomous farming machine. The boom may include one or more lights configured to illuminate the ground surface in front of the boom when the autonomous farming machine operates at night. The lights may illuminate the ground surface when a presence of natural light is insufficient to illuminate the ground surface; the treatment module 212 is not limited to use at night (e.g., the time from sunset to sunrise). In one example, the ROI identification module 320 detects 710 brightness levels for points on a ground surface in front of a boom (e.g., the mounting mechanism 140) of the farming machine 100 of FIGS. 1A-1C. The ROI identification module 320 may analyze brightness of pixel values of images captured by the camera(s) (e.g., one of the sensors 236) to detect 710 the brightness levels.

The treatment module 212 identifies 720 a region of interest corresponding to a portion of the ground surface. For example, the ROI identification module 320 can identify 720 an ROI in substantially real-time as the farming machine 100 is traveling through a field by determining a portion of an image captured of the ground surface in front of a boom that includes pixel values having an above-threshold detected brightness level. An example of an identified ROI is shown in FIGS. 5, 6A, and 6B. In some embodiments, the ROI identification module 320 may use a calibrated ROI, determined by the calibration module 330, to determine a pixel location of an ROI was previously calibrated to be located.

The treatment module 212 detects 730 a plant within the identified region of interest. For example, the plant identification module 310 can detect 730 the weed 512 within the identified ROI 520. The plant identification module 310 may use one or more of the models 350 to detect 730 the weed 512.

The treatment module 212 selects 740 an action based on the detected plant. For example, the action module 340 may select 740 to spray an herbicide in response to the plant identification module 310 detecting 730 the weed 512 within the identified ROI 520.

The treatment module 212 performs 750 the selected action at a delayed time based on a location of the region of interest. For example, the action module 340 may perform 750 the spraying by generating instructions to actuate a nozzle of the farming machine 100 to release the herbicide at a delayed time. The action module 340 may determine the delayed time using the location of the region of interest. For example, the action module 340 may determine a location of the ROI based on a distance to the ROI from the camera, which can be determined using the angle and height of the camera. The action module 340 may delay transmitted the generated instruction to immediately actuate the nozzle or the action module 340 may transmit a generated instruction to delay actuating the nozzle.

### IV. Control System

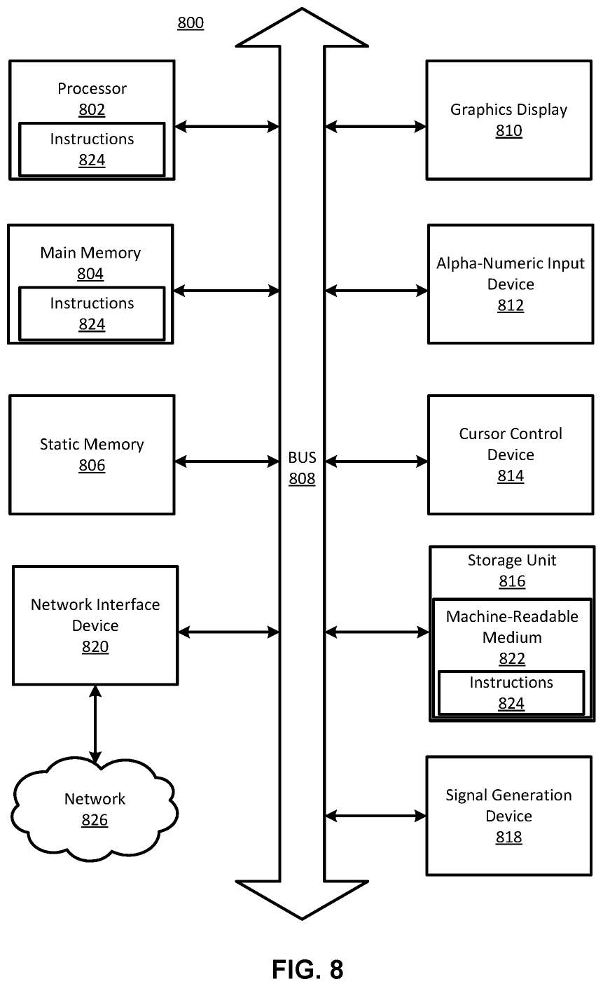

FIG. 8 is a block diagram illustrating components of an example machine for reading and executing instructions from a machine-readable medium. Specifically, FIG. 8 shows a diagrammatic representation of control system 130 in the example form of a computer system 800. The computer system 800 can be used to execute instructions 824 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processing units (generally processor 802). The processor 802 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 800 also includes a main memory 804. The computer system may include a storage unit 816. The processor 802, memory 804, and the storage unit 816 communicate via a bus 808.

In addition, the computer system 800 can include a static memory 806, a graphics display 810 (e.g., to drive a plasma display panel (PDP), a liquid crystal display (LCD), or a projector). The computer system 800 may also include alphanumeric input device 812 (e.g., a keyboard), a cursor control device 55 (e.g., a mouse, a trackball, a joystick, a motion sensor, or other pointing instrument), a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. For example, the instructions 824 may include the functionalities of modules of the system 130 described in FIG. 2. The instructions 824 may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 may be transmitted or received over a network 826 (e.g., network 240) via the network interface device 820.

### V. Additional Considerations

The description above refers to various modules and models capable of performing various algorithms and calculating various characteristics. Notably, the various models may take any number of forms. For instance, a single model can both identify plants in an image and calculate performance characteristics (e.g., using a single encoder and two decoders). Alternatively or additionally, a first model can identify plants and a second model can calculate performance characteristics (e.g., a first encoder and decoder, and a second encoder and decoder). Alternatively or additionally, each model is capable of modifying itself or another model according to the principles described hereinabove. For instance, a first result of a first model can modify a second model, or a model may modify itself based on its own results.

In the description above, for purposes of explanation, numerous specific details are set forth in order to provide a thorough understanding of the illustrated system and its operations. It will be apparent, however, to one skilled in the art that the system can be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer physically mounted within a machine. This computer may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements but may include other elements not expressly listed or inherent to such process, method, article or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the system. This description should be read to include one or at least one and the singular also includes the plural unless it is obvious that it is meant otherwise.

As referred to herein, “substantially” or “approximately” may indicate an error margin of +/−10% unless specified otherwise from the context in which the term is used. For example, “substantially real-time” may refer to +/−10% of a second from the current time.

Upon reading this disclosure, those of skill in the art will appreciate still additional alternative structural and functional designs for a system and a process for identifying and treating plants with a farming machine including a control system executing a semantic segmentation model. Thus, while particular embodiments and applications have been illustrated and described, it is to be understood that the disclosed embodiments are not limited to the precise construction and components disclosed herein. Various modifications, changes and variations, which will be apparent to those, skilled in the art, may be made in the arrangement, operation and details of the method and apparatus disclosed herein without departing from the spirit and scope defined in the appended claims.

What is claimed is:

1. A method comprising:
detecting, by an autonomous farming machine, a brightness level at each of a plurality of points of a ground surface in front of a boom of the autonomous farming machine, the boom comprising one or more lights configured to illuminate the ground surface in front of the boom when the autonomous farming machine operates at night;
identifying, by the autonomous farming machine, a region of interest corresponding to a portion of the ground surface in front of the boom corresponding to an above-threshold detected brightness level;
detecting, by the autonomous farming machine, a plant within the identified region of interest;
selecting, by the autonomous farming machine, an action based on the detected plant; and
performing, by the autonomous farming machine, the selected action at a delayed time based on a location of the region of interest.

2. The method of claim 1, wherein detecting the brightness level at each of the plurality of points of the ground surface in front of the boom comprises:
for a plurality of partitions of an image of the ground surface along a first dimension of the image:
determining the brightness level of a plurality of image pixels along a second dimension of the image, wherein the plurality of points correspond to the plurality of image pixels, and wherein the first dimension is orthogonal to the second dimension.

3. The method of claim 2, wherein identifying the region of interest comprises determining a region within the image comprising pixels having the above-threshold detected brightness level.

4. The method of claim 3, wherein determining the region within the image comprise:
determining, along the second dimension, two or more boundary lines, wherein the region comprises pixels having values in the second dimension that are bounded by the two or more boundary lines.

5. The method of claim 1, further comprising:
determining the location of the region of interest; and
determining the delayed time based on a speed of the autonomous farming machine and the location of the region of interest.

6. The method of claim 1, wherein region of interest comprises a fixed area.

7. The method of claim 1, wherein the region of interest is a first region of interest associated with the boom configured at a first height, further comprising:
for each of a plurality of heights at which the boom is configurable:
identifying a respective region of interest associated with the boom configured at the height, wherein the respective region of interest corresponds to a respective portion of the ground surface in front of the boom, the respective portion corresponding to the above-threshold detected brightness level.

8. The method of claim 1, further comprising:
in response to determining, based on a first image, a first brightness level of a first point of the ground surface, determining an accuracy threshold for classifying a plant, wherein the first brightness level satisfies the above-threshold detected brightness level; and
in response to determining, based on a second image captured subsequent to the first image, a second brightness level of a second point of the ground surface, modifying the accuracy threshold for classifying the plant, wherein the second brightness level falls below the above-threshold detected brightness level.

9. The method of claim 1, further comprising:
determining a number of points of the ground surface in front of the boom having a brightness level at the above-threshold detected brightness level;
determining, based on the number of points, whether the one or more lights is illuminating the ground surface in front of the boom at the above-threshold detected brightness level.

10. The method of claim 9, further comprising:
in response to determining that the one or more lights is illuminating the ground surface in front of the boom below the above-threshold detected brightness level, generating a notification that the one or more lights are mounted at an incorrect angle.

11. A farming machine comprising:
a sensor configured for capturing images of plants in a field as the farming machine travels through the field;
a treatment array configured to treat plants;
a boom comprising one or more lights configured to illuminate a ground surface in front of the boom when the farming machine operates at night;
a processor;
a non-transitory computer readable storage medium storing computer program instructions, the computer program instructions, when executed by the processor, causing the processor to:
detect a brightness level at each of a plurality of points of the ground surface in front of a boom of the farming machine;
identify a region of interest corresponding to a portion of the ground surface in front of the boom corresponding to an above-threshold detected brightness level;
detect a plant within the identified region of interest;
select an action based on the detected plant; and
perform the selected action at a delayed time based on a location of the region of interest.

12. The farming machine of claim 11, wherein the region of interest is a first region of interest associated with the boom configured at a first height, and wherein the computer program instructions further comprise instructions that, when executed, causes the processor to:
for each of a plurality of heights at which the boom is configurable:
identify a respective region of interest associated with the boom configured at the height, wherein the respective region of interest corresponds to a respective portion of the ground surface in front of the boom, the respective portion corresponding to the above-threshold detected brightness level.

13. The farming machine of claim 11, wherein the computer program instructions further comprise instructions that, when executed, causes the processor to:
in response to determining, based on a first image, a first brightness level of a first point of the ground surface, determine an accuracy threshold for classifying a plant, wherein the first brightness level satisfies the above-threshold detected brightness level; and
in response to determining, based on a second image captured subsequent to the first image, a second brightness level of a second point of the ground surface, modify the accuracy threshold for classifying the plant, wherein the second brightness level falls below the above-threshold detected brightness level

14. The farming machine of claim 11, wherein the computer program instructions further comprise instructions that, when executed, causes the processor to:
determine a number of points of the ground surface in front of the boom having a brightness level at the above-threshold detected brightness level;
determine, based on the number of points, whether the one or more lights is illuminating the ground surface in front of the boom at the above-threshold detected brightness level.

15. The farming machine of claim 14, wherein the computer program instructions further comprise instructions that, when executed, causes the processor to:
in response to determining that the one or more lights is illuminating the ground surface in front of the boom below the above-threshold detected brightness level, generate a notification that the one or more lights are mounted at an incorrect angle.

16. A non-transitory computer readable storage medium storing computer program storing instructions, the computer program instructions, when executed by a processor, causing the processor to:
detect a brightness level at each of a plurality of points of a ground surface in front of a boom of the autonomous farming machine, the boom comprising one or more lights configured to illuminate the ground surface in front of the boom when the autonomous farming machine operates at night;
identify a region of interest corresponding to a portion of the ground surface in front of the boom corresponding to an above-threshold detected brightness level;
detect a plant within the identified region of interest;
select an action based on the detected plant; and
perform the selected action at a delayed time based on a location of the region of interest.

17. The non-transitory computer readable storage medium of claim 16, wherein the region of interest is a first region of interest associated with the boom configured at a first height, and wherein the computer program instructions further comprise instructions that, when executed, causes the processor to:
for each of a plurality of heights at which the boom is configurable:
identify a respective region of interest associated with the boom configured at the height, wherein the respective region of interest corresponds to a respective portion of the ground surface in front of the boom, the respective portion corresponding to the above-threshold detected brightness level.

18. The non-transitory computer readable storage medium of claim 16, wherein the computer program instructions further comprise instructions that, when executed, causes the processor to:
in response to determining, based on a first image, a first brightness level of a first point of the ground surface, determine an accuracy threshold for classifying a plant, wherein the first brightness level satisfies the above-threshold detected brightness level; and
in response to determining, based on a second image captured subsequent to the first image, a second brightness level of a second point of the ground surface, modify the accuracy threshold for classifying the plant, wherein the second brightness level falls below the above-threshold detected brightness level.

19. The non-transitory computer readable storage medium of claim 16, wherein the computer program instructions further comprise instructions that, when executed, causes the processor to:
determine a number of points of the ground surface in front of the boom having a brightness level at the above-threshold detected brightness level;
determine, based on the number of points, whether the one or more lights is illuminating the ground surface in front of the boom at the above-threshold detected brightness level.

20. The non-transitory computer readable storage medium of claim 19, wherein the computer program instructions further comprise instructions that, when executed, causes the processor to:
in response to determining that the one or more lights is illuminating the ground surface in front of the boom below the above-threshold detected brightness level, generate a notification that the one or more lights are mounted at an incorrect angle.
